(19) United States
(12) Patent Application Publication
(10) Pub. No.: US 2025/0360803 A1
(43) Pub. Date: Nov. 27, 2025

(54) SYSTEM AND METHOD FOR OPTIMIZING PERFORMANCE IN FUEL CELL ELECTRIC VEHICLES

(71) Applicant: JIO PLATFORMS LIMITED, Ahmedabad (IN)

(72) Inventors: Rajesh Booravalli Seetharama SASTRY, Bangalore (IN); Satya Prakash PANDEY, Dombivili (IN); Bipul KUMAR, Bihar (IN); Gulprit SINGH, Bengaluru (IN)

(73) Assignee: JIO PLATFORMS LIMITED, Ahmedabad (IN)

(21) Appl. No.: 19/217,940

(22) Filed: May 23, 2025

(30) Foreign Application Priority Data
May 25, 2024 (IN) 202421040792

(51) Int. Cl. B60L 15/20; B60L 50/75; B60L 58/30; B60L 58/40

(52) U.S. Cl. CPC B60L 15/2045; B60L 50/75; B60L 58/30; B60L 58/40; B60L 2240/12; B60L 2240/642; B60L 2240/647; B60L 2240/662

(57) ABSTRACT

The present disclosure provides a system (102) and a method for optimizing performance in fuel cell electric vehicles. The system (102) receives one or more parameters associated with a vehicle through one or more sensors configured to the vehicle. The system (102) determines a condition associated with the vehicle based on the one or more parameters. The system (102), in response to a determination that a primary source and a secondary source are functional, enables via an artificial intelligence (AI) engine, switching of power supplied through the primary source and the secondary source at one or more predetermined intervals based on the condition. The system (102) enables automatic selection of the power source based on the operating conditions to optimize the performance of the vehicle. Further, the system (102) enables failure prediction, mitigation, and further enables fuel efficiency, prevents vehicle downtime, and provides predictive failure of components.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to energy management systems in vehicles. More particularly, the present disclosure relates to a system and a method for optimizing performance in fuel cell electric vehicles (FCEV).

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Energy consumption varies depending on multiple factors such as inclination, aging of components, and configuration of parameters depending on the vehicle drive patterns. The vehicle's maximum energy consumption occurs with varying inclination, increases with an increase in the angle of inclination and decreases with a decrease in the angle of inclination. Multiple major factors like State of Charge (SOC), State of Power (SOP), Heating, Ventilation, Air conditioning (HVAC) also influence the energy consumption. Further, calibration, cooling/heating and high/low temperature also influence the energy consumption and vary depending on the route of the vehicle.

Conventional systems are inefficient in optimizing the energy consumption. There is, therefore, a need in the art to provide a system and a method that can mitigate the problems associated with the conventional systems and provide an efficient system that may optimize the energy consumption.

### OBJECTS OF THE INVENTION

Some of the objects of the present disclosure, which at least one embodiment herein satisfies are listed herein below.

It is an object of the present disclosure to provide a system and a method that provides optimal energy support during various operating conditions of a vehicle.

It is an object of the present disclosure to provide a system that records multiple parameters associated with the vehicle during various operating conditions of a vehicle.

It is an object of the present disclosure to provide a system and a method that uses artificial intelligence (AI) for switching of power supplied by multiple sources at predetermined intervals based on the vehicle condition and the recorded parameters.

It is an object of the present disclosure to provide a system that predicts failures associated with various components of the vehicle, alerts the severity of the failure, and assists in rectifying the failure.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a hybrid power system for a vehicle. The system includes a processor and a memory operatively coupled with the processor where said memory stores instructions which, when executed by the processor, cause the processor to receive one or more parameters associated with a vehicle through one or more sensors configured to the vehicle. The vehicle is powered by a primary source and a secondary source. The processor determines a condition associated with the vehicle based on the one or more parameters. The processor, in response to a determination that the primary source and the secondary source are functional, enables via an artificial intelligence (AI) engine, switching of power supplied through the primary source and the secondary source at one or more predetermined intervals based on the condition.

In an embodiment, the primary source may be a hydrogen powered fuel cell and the secondary source may be a battery.

In an embodiment, the one or more parameters may include at least one of a road inclination, a road condition, a pressure associated with an accelerator of the vehicle, a state of charge (SOC) of the battery management system, a fuel level, a weather condition, one or more braking conditions associated with the vehicle, a vehicle speed, a state of power (SOP) of the vehicle, a voltage level associated with the battery, a Heating, Ventilation, and Air Conditioning (HVAC) associated with the vehicle.

In an embodiment, in response to the condition that a fuel level in the hydrogen powered fuel cell is diminishing, the processor may power the vehicle through the battery for the one or more predetermined intervals.

In an embodiment, upon the condition associated with the one or more braking conditions, the processor may power the vehicle through the battery for the one or more predetermined intervals.

In an embodiment, upon the condition that the weather condition is cold, the processor may switch the powering of the vehicle between the hydrogen powered fuel cell and the battery for the one or more predetermined intervals.

In an embodiment, upon the condition that the road inclination is uphill, the processor may power the vehicle using the BMS for the one or more predetermined intervals and disallow charging of the battery. Upon the condition that the road inclination is downhill, the processor may minimize powering the vehicle through the battery for the one or more predetermined intervals.

In an embodiment, upon the condition that the road condition is rugged, the processor may power the vehicle through the battery for the one or more predetermined intervals. Upon the condition that the road condition is smooth, the processor may power the vehicle through the hydrogen powered fuel cell for the one or more predetermined intervals.

In an embodiment, upon the condition that the vehicle speed is constant for a period, the processor may power the power the vehicle through the hydrogen powered fuel cell for the one or more predetermined intervals.

In an embodiment, upon the condition that the voltage level associated with the battery is diminishing, the processor may disallow powering the vehicle through the battery for the one or more predetermined intervals.

In an embodiment, upon the condition of an increase in the pressure associated with an accelerator of the vehicle, the processor may power the vehicle through the battery for the one or more predetermined intervals.

In an embodiment, the processor may determine one or more stress factors associated with at least one component of the vehicle associated with the condition for the one or more predetermined intervals. The processor may predict via the AI engine, a failure associated with said at least one component of the vehicle. The processor may minimize usage of said at least one component and assist a user in rectifying the failure.

In an aspect, the present disclosure relates to a method for a hybrid power system. The method includes receiving, by a processor, associated with a hybrid power system, one or more parameters associated with a vehicle through one or more sensors configured to the vehicle. The vehicle is powered by a primary source and a secondary source. The method includes determining, by the processor, a condition associated with the vehicle based on the one or more parameters. The method includes, in response to a determination that the primary source and the secondary source are functional, enabling by the processor, via an artificial intelligence (AI) engine, switching of power supplied through the primary source and the secondary source at one or more predetermined intervals based on the condition.

In an embodiment, the primary source may be a hydrogen powered fuel cell and the secondary source may be a battery.

In an embodiment, the one or more parameters may include at least one of a road inclination, a road condition, a pressure associated with an accelerator of the vehicle, a SOC of the battery management system, a fuel level, a weather condition, one or more braking conditions associated with the vehicle, a vehicle speed, a SOP of the vehicle, a voltage level associated with the battery, a HVAC associated with the vehicle.

In an embodiment, the method may include powering, by the processor, in response to the condition that a fuel level in the hydrogen powered fuel cell is diminishing, the vehicle through the battery for the one or more predetermined intervals.

In an embodiment, the method may include powering, by the processor, upon the condition associated with the one or more braking conditions, the vehicle through the battery for the one or more predetermined intervals.

In an embodiment, the method may include switching, by the processor, upon the condition that the weather condition is cold, the powering of the vehicle between the hydrogen powered fuel cell and the battery for the one or more predetermined intervals.

In an embodiment, the method may include powering, by the processor, upon the condition that the road inclination is uphill, the vehicle using the BMS for the one or more predetermined intervals and disallowing charging of the battery and the method may include minimizing powering, by the processor, the vehicle through the battery for the one or more predetermined intervals.

In an embodiment, the method may include powering, by the processor, upon the condition that the road condition is rugged, the vehicle through the battery for the one or more predetermined intervals and the method may include powering, by the processor, upon the condition that the road condition is smooth the vehicle through the hydrogen powered fuel cell for the one or more predetermined intervals.

In an embodiment, the method may include powering, by the processor, upon the condition that the vehicle speed is constant for a period, the vehicle through the hydrogen powered fuel cell for the one or more predetermined intervals.

In an embodiment, the method may include disallowing, by the processor, upon the condition that the voltage level associated with the battery is diminishing, the powering of the vehicle through the battery for the one or more predetermined intervals.

In an embodiment, the method may include powering, by the processor, upon the condition of an increase in the pressure associated with an accelerator of the vehicle, the vehicle through the battery for the one or more predetermined intervals.

In an embodiment, the method may include determining, by the processor, one or more stress factors associated with at least one component of the vehicle associated with the condition for the one or more predetermined intervals. The method may include predicting via the AI engine, a failure associated with said at least one component of the vehicle. The method may include minimizing usage of said at least one component and assisting a user in rectifying the failure.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an example architecture (100) of the proposed system (102), in accordance with an embodiment of the present disclosure.

FIG. 2 illustrates an example block diagram (200) of a proposed system (102), in accordance with an embodiment of the present disclosure.

FIG. 3 illustrates an example representation of a model diagram (300) of the proposed system (102), in accordance with an embodiment of the present disclosure.

FIGS. 4A-4D illustrate example representations of block diagrams (400A, 4000B, 400C, 400D), of the proposed system (102), in accordance with embodiments of the present disclosure.

FIGS. 5A-5B illustrates example representations of a failure prediction block diagram (500A, 500B) of the proposed system (102), in accordance with embodiments of the present disclosure.

FIG. 6 illustrates an example computer system (600) in which or with which embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present disclosure describes energy management in a Fuel Cell Electric Vehicles (FCEV). FCEV's are powered using hydrogen and do not emit harmful tailpipe emission, only releasing water vapor and warm air into the atmosphere. The vehicle energy consumption varies based on inclination, aging of components, configuration of parameters and vehicle drive patterns. Vehicle's maximum energy consumption occurs with varying inclination and increases with an increase in the angle of inclination and decreases with a decrease in the angle of inclination. The FCEV uses a hydrogen powered fuel cell as the primary source of power and uses a battery as a secondary source of power. Depending on the vehicle's energy health and energy intensity, a system is incorporated that uses a strategic energy source between the FCEV and battery based on the vehicle's performance. This provides switching between the energy sources (hydrogen powered fuel cell, battery) during maximum energy consumption of the vehicle.

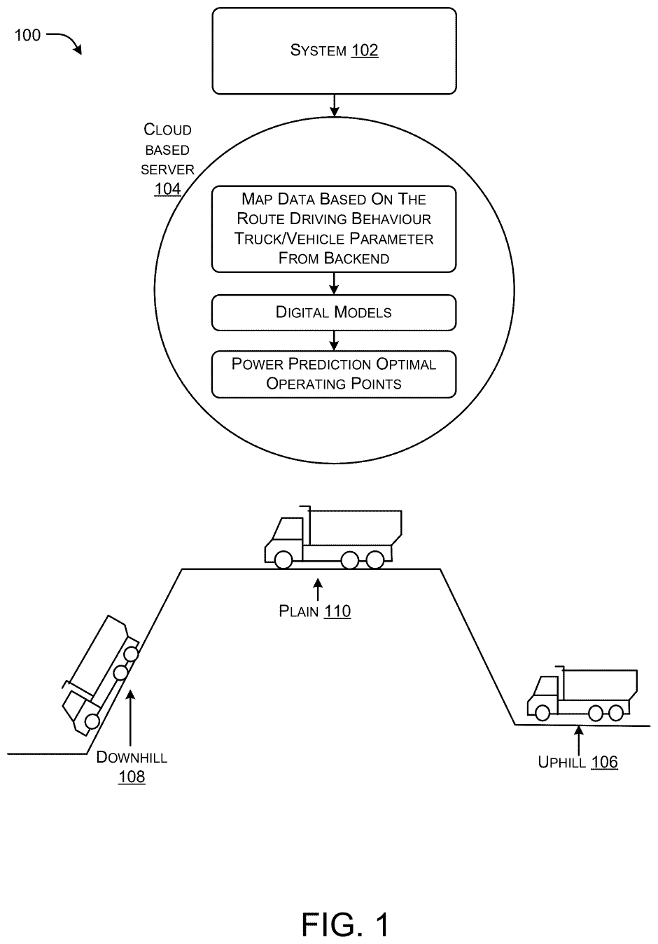

Various embodiments of the present disclosure will be explained in detail with reference to FIGS. 1-6.

FIG. 1 illustrates an example architecture (100) of the proposed system (102), in accordance with an embodiment of the present disclosure.

As illustrated in FIG. 1, in an embodiment, the system (102) may receive information from a cloud based server (104). The cloud based server (104) may be updated with vehicle testing data. The cloud based server (104) may map data (106) based on a driving route, a driving behaviour, a vehicle parameter. Further, the cloud based server (104) may generate one or more digital models based on the data. The cloud based server (104) may generate optimal operating points for predicting power based switching via the system (102). A person skilled in the art may understand that the vehicle may include an electric vehicle.

In an embodiment, the system (102) may detect if a road condition is uphill (106), downhill (108), or plain (110) and enable via an artificial intelligence (AI) engine, switching of power supplied through a primary source and a secondary source at one or more predetermined intervals based on the road condition. A person skilled in the art may understand that the primary source may include a hydrogen powered fuel and the secondary source may include the battery. As the vehicle's maximum energy consumption occurs with varying inclination and increases with an increase in the angle of inclination and decreases with a decrease in the angle of inclination, the system (102) may enable switching of power supplied through the primary sources and the secondary sources. For example, in case of the uphill/downhill road condition, time may be utilized by the hydrogen powered fuel cell to convert from hydrogen to power and reduce heat/thermal acceleration. Hence, the system (102) may switch to the battery for supplying power to the vehicle.

For example, in an embodiment, in the case of uphill more power may be implemented by the system (102) using the battery and in case of downhill power may be reduced by removing the battery source as well as the reducing the flow of the hydrogen from a hydrogen cylinder to the hydrogen powered fuel cell while maintaining the speed using gravity and inertia. In an instance, if the speed of the vehicle starts reducing the system (102) may increase the flow of hydrogen to maintain the speed. In case of a plain, the system (102) may maintain an equilibrium state in between the energy sources (hydrogen powered fuel cell, battery). Reducing the supply during downhill and maintaining the equilibrium state during the plain may optimize the performance of the vehicle.

In an embodiment, adding the battery during the uphill may boost the power. The system (102) may use a 3-axis accelerometer and gyroscope for the detecting the road inclination. The system (102) may detect the road inclination based on an angle and runtime, where a threshold for the angle and the runtime may be utilized.

In an embodiment, the system (102) may receive one or more parameters associated with a vehicle through one or more sensors configured to the vehicle. The one or more parameters may include but not limited to a road inclination, a road condition, a pressure associated with an accelerator of the vehicle, a state of charge (SOC) of the battery management system, a fuel level, a weather condition, one or more braking conditions associated with the vehicle, a vehicle speed, a state of power (SOP) of the vehicle, a voltage level associated with the battery, a Heating, Ventilation, and Air Conditioning (HVAC) associated with the vehicle.

In an embodiment, the system (102) may utilize one or more motion sensors, one or more Hall effect sensors, a pressure sensor, a temperature and humidity sensor, a Battery Management System (BMS), and a thermal runway sensor for detecting the one or more parameters associated with a vehicle.

In an embodiment, the system (102) may determine a condition associated with the vehicle based on the one or more parameters. In response to a determination that the primary source and the secondary source are functional, the system (102) may enable via an artificial intelligence (AI) engine, switching of power supplied through the primary source and the secondary source at one or more predetermined intervals based on the condition.

In an embodiment, in response to the condition that a fuel level in the hydrogen powered fuel cell is diminishing, the system (102) may power the vehicle through the battery for the one or more predetermined intervals.

In an embodiment, upon the condition associated with the one or more braking conditions, the system (102) may power the vehicle through the battery for the one or more predetermined intervals. For example, the system (102) may detect harsh braking using the 3-Axis Accelerometer and Gyroscope and use the battery as the source. In case of frequent braking/traffic area the system (102) may use the battery while on the highways/expressways the system (102) may use the hydrogen powered fuel cell as the source. Frequent braking, may be detected using the 3-Axis Accelerometer and Gyroscope.

In an embodiment, upon the condition that the weather condition is cold, the system (102) may switch the powering of the vehicle between the hydrogen powered fuel cell and the battery for the one or more predetermined intervals.

In an embodiment, upon the condition that the road inclination is uphill, the system (102) may power the vehicle using the battery for the one or more predetermined intervals and disallow charging of the battery. Further, the system (102) may upon the condition that the road inclination is downhill, minimize powering the vehicle through the battery for the one or more predetermined intervals.

In an embodiment, the system (102) upon the condition that the road condition is rugged, power the vehicle through the battery for the one or more predetermined intervals. Further, the system (102) may upon the condition that the road condition is smooth, may power the vehicle through the hydrogen powered fuel cell for the one or more predetermined intervals. The system (102) may detect the road condition using the 3-Axis Accelerometer and Gyroscope.

In an embodiment, the system (102) upon the condition that the vehicle speed is constant for a period, may power the power the vehicle through the hydrogen powered fuel cell for the one or more predetermined intervals.

In an embodiment, the system (102) upon the condition that the voltage level associated with the battery is diminishing, may disallow powering the vehicle through the battery for the one or more predetermined intervals.

In an embodiment, the system (102) upon the condition of an increase in the pressure associated with an accelerator of the vehicle, may power the vehicle through the battery for the one or more predetermined intervals.

In an embodiment, the system (102) may determine one or more stress factors associated with at least one component of the vehicle associated with the condition for the one or more predetermined intervals. Further, the system (102) may predict via the AI engine, a failure associated with said at least one component of the vehicle. The system (102) may minimize usage of said at least one component and assist a user in rectifying the failure.

Hence, the system (102) may provide connectivity among the vehicles bringing enormous benefits based on information received from the vehicle modules. The system (102) may provide real time information of the vehicle, dynamically configuring modules based on the algorithms used by the AI engine. The system (102) may provide information about the aging of components present in the vehicle so that predictive failures and analysis may be performed. Further, the system (102) may set the limit in speed or configure based on the information received from the cloud based server (104).

In an embodiment, based on the priority levels the system (102) may compute weightage associated with the one or more parameters and generate an output. The output may include a cumulative response that may give a percentage contribution of the hydrogen powered fuel cell in a total power drained by an engine of the vehicle.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

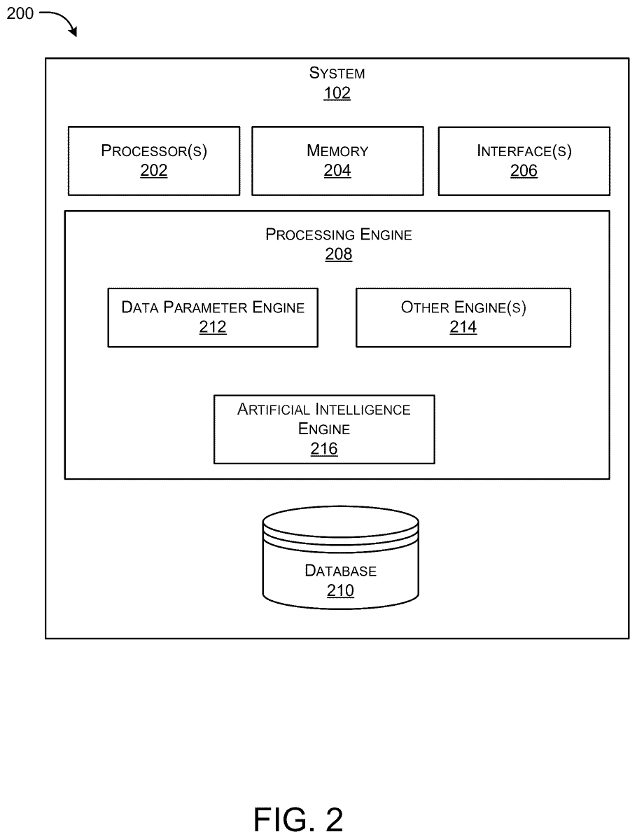

FIG. 2 illustrates an example block diagram (200) of a proposed system (134), in accordance with an embodiment of the present disclosure.

Referring to FIG. 2, the system (134) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (134). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (134) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (102). Examples of such components include, but are not limited to, processing engine(s) (208) and a database (210), where the processing engine(s) (208) may include, but not be limited to, a data ingestion engine (212), other engine(s) (214) and an AI engine (216). In an embodiment, the other engine(s) (214) may include, but not limited to, a data management engine, an input/output engine, and a notification engine.

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (102) may comprise the machine-readable storage medium storing the instructions and the processing resource to execute the instructions, or the machine-readable storage medium may be separate but accessible to the system (102) and the processing resource. In other examples, the processing engine(s) (208) may be implemented by electronic circuitry.

In an embodiment, the processor (202) may receive one or more parameters via the data ingestion engine (212). The processor (202) may store the one or more parameters in the database (210). The one or more parameters may be associated with a vehicle and detected one or more sensors configured to the vehicle. The vehicle may be powered by a primary source and a secondary source;

In an embodiment, the one or more parameters may include but not limited to a road inclination, a road condition, a pressure associated with an accelerator of the vehicle, a SOC of the battery management system, a fuel level, a weather condition, one or more braking conditions associated with the vehicle, a vehicle speed, a SOP of the vehicle, a voltage level associated with the battery, a HVAC associated with the vehicle.

In an embodiment, the processor (202) may utilize one or more motion sensors, one or more Hall effect sensors, a pressure sensor, a temperature and humidity sensor, a BMS, and a thermal runway sensor for detecting the one or more parameters associated with a vehicle.

In an embodiment, the processor (202) may determine a condition associated with the vehicle based on the one or more parameters. In response to a determination that the primary source and the secondary source are functional, the system (102) may enable via the AI engine (216), switching of power supplied through the primary source and the secondary source at one or more predetermined intervals based on the condition.

In an embodiment, in response to the condition that a fuel level in the hydrogen powered fuel cell is diminishing, processor (202) may power the vehicle through the battery for the one or more predetermined intervals.

In an embodiment, upon the condition associated with the one or more braking conditions, the processor (202) may power the vehicle through the battery for the one or more predetermined intervals. For example, the processor (202) may detect harsh braking using the 3-Axis Accelerometer and Gyroscope and use the battery as the source. In case of frequent braking/traffic area the processor (202) may use the battery while on the highways/expressways the processor (202) may use the hydrogen powered fuel cell as the source. Frequent braking, may be detected using the 3-Axis Accelerometer and Gyroscope.

In an embodiment, upon the condition that the weather condition is cold, the processor (202) may switch the powering of the vehicle between the hydrogen powered fuel cell and the battery for the one or more predetermined intervals.

In an embodiment, upon the condition that the road inclination is uphill, the processor (202) may power the vehicle using the battery for the one or more predetermined intervals and disallow charging of the battery. Further, the processor (202) may upon the condition that the road inclination is downhill, minimize powering the vehicle through the battery for the one or more predetermined intervals.

In an embodiment, the processor (202) upon the condition that the road condition is rugged, power the vehicle through the battery for the one or more predetermined intervals. Further, the processor (202) may upon the condition that the road condition is smooth, may power the vehicle through the hydrogen powered fuel cell for the one or more predetermined intervals. The processor (202) may detect the road condition using the 3-Axis Accelerometer and Gyroscope.

In an embodiment, the processor (202) upon the condition that the vehicle speed is constant for a period, may power the power the vehicle through the hydrogen powered fuel cell for the one or more predetermined intervals.

In an embodiment, the processor (202) upon the condition that the voltage level associated with the battery is diminishing, may disallow powering the vehicle through the battery for the one or more predetermined intervals.

In an embodiment, the processor (202) upon the condition of an increase in the pressure associated with an accelerator of the vehicle, may power the vehicle through the battery for the one or more predetermined intervals.

In an embodiment, the processor (202) may determine one or more stress factors associated with at least one component of the vehicle associated with the condition for the one or more predetermined intervals. Further, the processor (202) may predict via the AI engine (216), a failure associated with said at least one component of the vehicle. The processor (202) may minimize usage of said at least one component and assist a user in rectifying the failure.

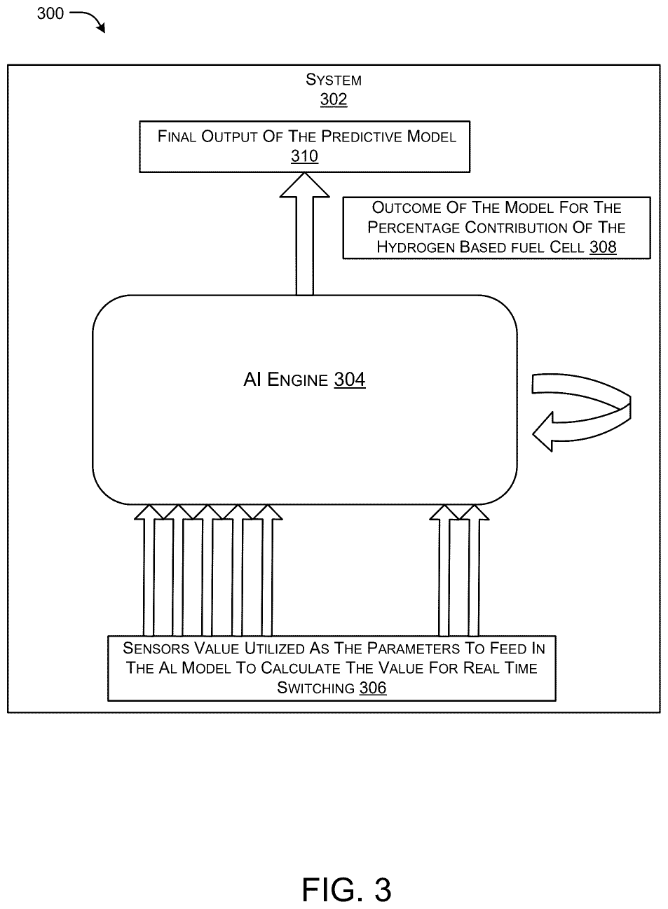

FIG. 3 illustrates an example representation of a model diagram (300) of the proposed system (102), in accordance with an embodiment of the present disclosure. A person skilled in the art may understand that the system (302) may be similar to the system (102) of FIG. 1.

As illustrated in FIG. 3, in an embodiment, the system (302) may include the AI engine (304) that may receive one or more parameters from the one or more sensors configured on a vehicle. The one or more sensor values may be utilized (306) by the AI engine (304) to determine the one or more parameters. Further, the AI engine (304) may perform model training and model testing (308) to process the one or more parameters. The system (302) may determine (310) a percentage contribution of the hydrogen based fuel cell. The system (102) may generate (312) a final output based on the predictive model.

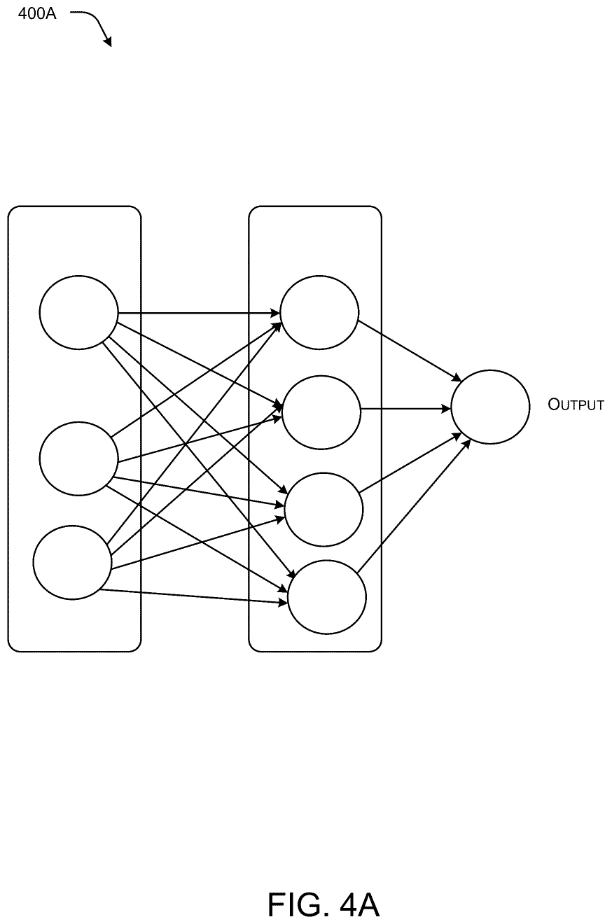

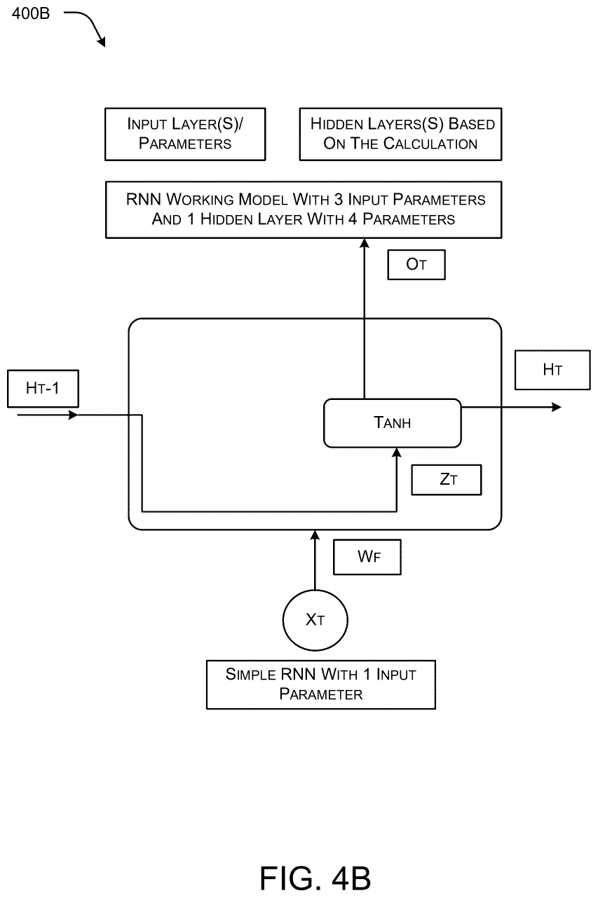

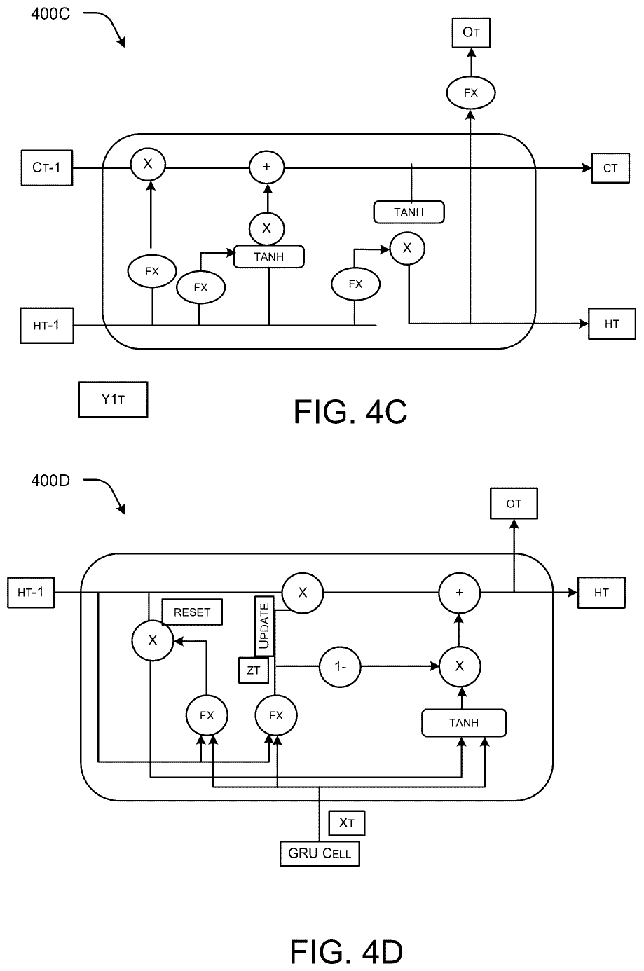

FIGS. 4A-4D illustrate example representations of block diagrams (400A, 400B, 400C, 400D), of the proposed system (102), in accordance with embodiments of the present disclosure.

As illustrated in FIGS. 4A-4D, in an embodiment, the system (102) may use a Recurrent Neural Network (RNN) for converting sequential data input into a sequential data output. Further, the RNB may utilize Long Short-Term Memory (LSTM) or Gated Recurrent Unit (GRU) for processing datasets based on testing/evaluation time. The system (102) may determine an optimization level achieved by the LSTM, GRU and process the datasets.

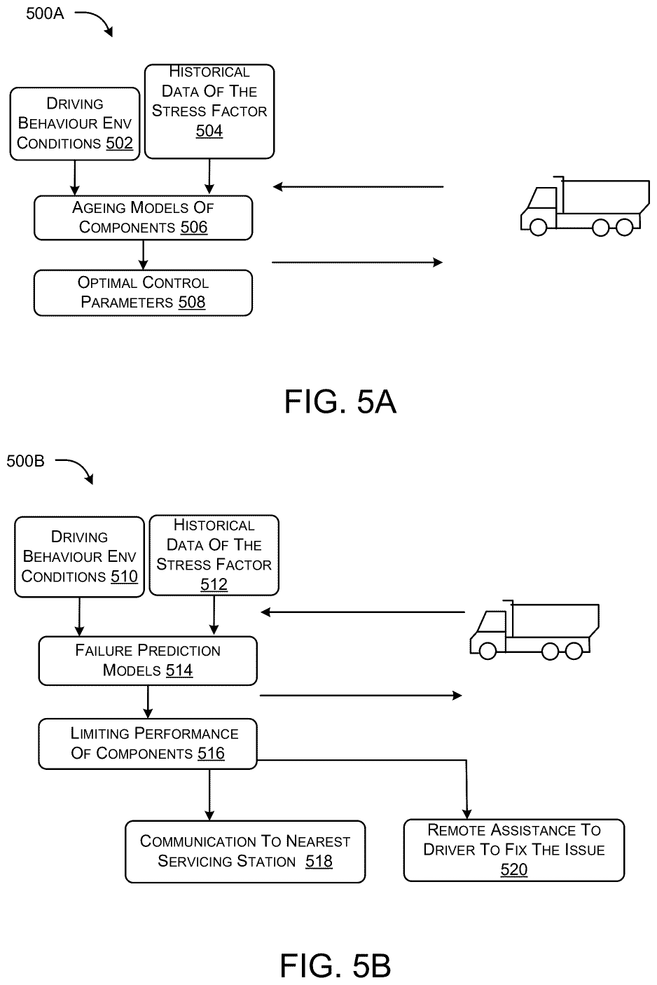

FIGS. 5A-5B illustrates example representations of a failure prediction block diagram (500A, 500B) of the proposed system (102), in accordance with embodiments of the present disclosure.

In an embodiment, the system (102) may determine one or more stress factors associated with at least one component of the vehicle associated with the condition for the one or more predetermined intervals. For example, the aging factor may include but not limited to a battery charging-discharging cycle, a battery capacity, a SOH of the battery, a battery consumption, a FCEV battery health (including a charging Status, a temperature range, a hydrogen tank data, an electrode health, and a GFC), a Revolutions Per Minute (RPM) of a motor of the FCEV, and the HVAC. With the help of the IoT server (104), the system (102) may determine the one or more stress factors on the components and maintain the historical data of stress factors. Depending on the driver behaviour pattern and ageing of components, the system (102) may set the optimal control parameters for efficient functioning of FCEV.

As illustrated in FIG. 5A, in an embodiment, the system (102) may receive (502) a driving behaviour based on environmental conditions. The system (102) may receive (504) historical data based on the one or more stress factors. Further, the system (102) may determine (506) ageing associated with the components. The system (102) may generate (508) optimal control parameters based on the ageing.

As illustrated in FIG. 5B, in an embodiment, the system (102) may may receive (510) a driving behaviour based on environmental conditions. The system (102) may receive (512) historical data based on the one or more stress factors. Further, the system (102) may utilize (514) failure prediction models to predict failure of the components based on the ageing. The system (102) may limit (516) performance of the components. The system (102) may communicate (518) to a nearest service station. The system (102) may provide (520) remote assistance to a driver to a driver of the vehicle during the failure.

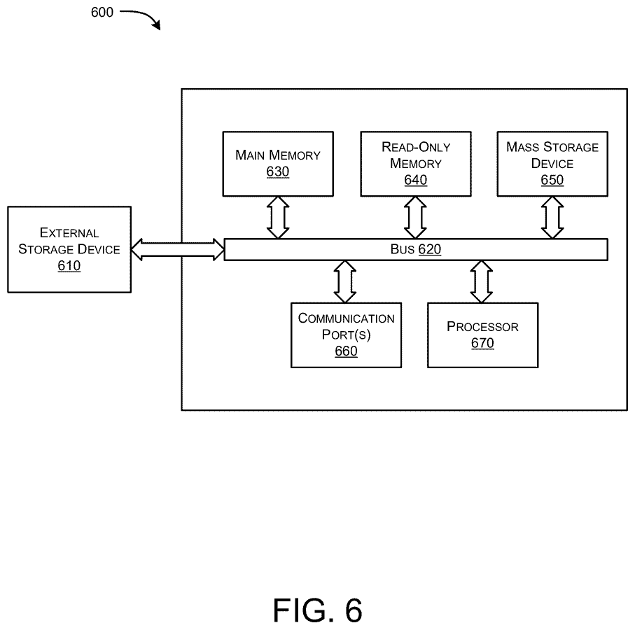

FIG. 6 illustrates an exemplary computer system (600) in which or with which embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that provides optimal energy support during various operating conditions of a vehicle.

The present disclosure provides a system that enables automatic selection of the power source between a hydrogen powered fuel cell and a battery based on the operating conditions to optimize the performance of the vehicle.

The present disclosure provides a system that enables failure prediction and mitigation associated with parameter of the vehicle.

The present disclosure provides a system that enables fuel efficiency, prevents vehicle downtime, and provides predictive failure of components

I/We claim:

1. A hybrid power system (102) for a vehicle, the system (102) comprising:
a processor (202);
a memory (204) operatively coupled with the processor (202), wherein said memory (204) stores instructions which, when executed by the processor (202), cause the processor (202) to:
receive one or more parameters associated with a vehicle through one or more sensors configured to the vehicle, wherein the vehicle is powered by a primary source and a secondary source;
determine a condition associated with the vehicle based on the one or more parameters; and
in response to a determination that the primary source and the secondary source are functional, enable via an artificial intelligence (AI) engine, switching of power supplied through the primary source and the secondary source at one or more predetermined intervals based on the condition.

2. The system (102) as claimed in claim 1, wherein the primary source is a hydrogen powered fuel cell and the secondary source is a battery.

3. The system (102) as claimed in claim 2, wherein the one or more parameters comprise at least one of: a road inclination, a road condition, a pressure associated with an accelerator of the vehicle, a state of charge (SOC) of the battery management system, a fuel level, a weather condition, one or more braking conditions associated with the vehicle, a vehicle speed, a state of power (SOP) of the vehicle, a voltage level associated with the battery, a Heating, Ventilation, and Air Conditioning (HVAC) associated with the vehicle.

4. The system (102) as claimed in claim 2, wherein in response to the condition that a fuel level in the hydrogen powered fuel cell is diminishing, the processor (202) is to power the vehicle through the battery for the one or more predetermined intervals.

5. The system (102) as claimed in claim 3, wherein upon the condition associated with the one or more braking conditions, the processor (202) is to power the vehicle through the battery for the one or more predetermined intervals.

6. The system (102) as claimed in claim 3, wherein upon the condition that the weather condition is cold, the processor (202) is to switch the powering of the vehicle between the hydrogen powered fuel cell and the battery for the one or more predetermined intervals.

7. The system (102) as claimed in claim 3, wherein the processor (202) is to:
upon the condition that the road inclination is uphill, power the vehicle using the battery for the one or more predetermined intervals and disallow charging of the battery;
upon the condition that the road inclination is downhill, minimize powering the vehicle through the battery for the one or more predetermined intervals.

8. The system (102) as claimed in claim 3, wherein the processor (202) is to:
upon the condition that the road condition is rugged, power the vehicle through the battery for the one or more predetermined intervals; and
upon the condition that the road condition is smooth, power the vehicle through the hydrogen powered fuel cell for the one or more predetermined intervals.

9. The system (108) as claimed in claim 3, wherein the processor (202) is to:
upon the condition that the vehicle speed is constant for a period, power the power the vehicle through the hydrogen powered fuel cell for the one or more predetermined intervals.

10. The system (102) as claimed in claim 3, wherein upon the condition that the voltage level associated with the battery is diminishing, the processor (202) is to disallow powering the vehicle through the battery for the one or more predetermined intervals.

11. The system (102) as claimed in claim 3, wherein upon the condition of an increase in the pressure associated with an accelerator of the vehicle, the processor (202) is to power the vehicle through the battery for the one or more predetermined intervals.

12. The system (102) as claimed in claim 1, wherein the processor (202) is to:
determine one or more stress factors associated with at least one component of the vehicle associated with the condition for the one or more predetermined intervals;
predict via the AI engine, a failure associated with said at least one component of the vehicle; and
minimize usage of said at least one component and assist a user in rectifying the failure.

13. A method for a hybrid power system, the method comprising:
receiving, by a processor (202), associated with a hybrid power system (102), one or more parameters associated with a vehicle through one or more sensors configured to the vehicle, wherein the vehicle is powered by a primary source and a secondary source;
determining, by the processor (202), a condition associated with the vehicle based on the one or more parameters; and
in response to a determination that the primary source and the secondary source are functional, enabling by the processor (202), via an artificial intelligence (AI) engine, switching of power supplied through the primary source and the secondary source at one or more predetermined intervals based on the condition.

14. The method as claimed in claim 13, wherein the primary source is a hydrogen powered fuel cell and the secondary source is a battery.

15. The method as claimed in claim 13, wherein the one or more parameters comprise at least one of: a road inclination, a road condition, a pressure associated with an accelerator of the vehicle, a state of charge (SOC) of the battery management system, a fuel level, a weather condition, one or more braking conditions associated with the vehicle, a vehicle speed, a state of power (SOP) of the vehicle, a voltage level associated with the battery, a Heating, Ventilation, and Air Conditioning (HVAC) associated with the vehicle.

16. The method as claimed in claim 14, comprising powering, by the processor (202), in response to the condition that a fuel level in the hydrogen powered fuel cell is diminishing, the vehicle through the battery for the one or more predetermined intervals.

17. The method as claimed in claim 15, comprising powering, by the processor (202), upon the condition associated with the one or more braking conditions, the vehicle through the battery for the one or more predetermined intervals.

18. The method as claimed in claim 15, comprising switching, by the processor (202), upon the condition that the weather condition is cold, the powering of the vehicle between the hydrogen powered fuel cell and the battery for the one or more predetermined intervals.

19. The method as claimed in claim 15, comprising powering, by the processor (202), upon the condition that the road inclination is uphill, the vehicle using the BMS for the one or more predetermined intervals and disallowing charging of the battery and comprising minimizing powering, by the processor, the vehicle through the battery for the one or more predetermined intervals.

20. The method as claimed in claim 15, comprising powering, by the processor (202), upon the condition that the road condition is rugged, the vehicle through the battery for the one or more predetermined intervals and comprising powering, by the processor, upon the condition that the road condition is smooth the vehicle through the hydrogen powered fuel cell for the one or more predetermined intervals.

21. The method as claimed in claim 15, comprising powering, by the processor (202), upon the condition that the vehicle speed is constant for a period, the vehicle through the hydrogen powered fuel cell for the one or more predetermined intervals.

22. The method as claimed in claim 15, comprising disallowing, by the processor (202), upon the condition that the voltage level associated with the battery is diminishing, the powering of the vehicle through the battery for the one or more predetermined intervals.

23. The method as claimed in claim 15, comprising powering, by the processor (202), upon the condition of an increase in the pressure associated with an accelerator of the vehicle, the vehicle through the battery for the one or more predetermined intervals.

24. The method as claimed in claim 15, comprising:
determining, by the processor (202), one or more stress factors associated with at least one component of the vehicle associated with the condition for the one or more predetermined intervals;
predicting via the AI engine, a failure associated with said at least one component of the vehicle; and
minimizing usage of said at least one component and assisting a user in rectifying the failure.
